(19) United States
(12) Patent Application Publication
(10) Pub. No.: US 2010/0333054 A1
(43) Pub. Date: Dec. 30, 2010

(54) CIRCUIT DESIGN ASSISTING APPARATUS

(75) Inventor: Yoichiro ISHIKAWA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/814,739

(22) Filed: Jun. 14, 2010

(30) Foreign Application Priority Data
Jun. 24, 2009 (JP) 2009-149320

(51) Int. Cl. G06F 17/50

(52) U.S. Cl. 716/106; 716/136

(57) ABSTRACT

A circuit design assisting apparatus for assisting a circuit design of a semiconductor by using a noise check result corresponding to a plurality of wiring arrangements, the circuit design assisting apparatus includes a database unit that stores the wiring arrangement data, a wire specifying unit that specifies a first wire from the wiring arrangement data, a wire extracting unit that extracts a plurality of second wires respectively including a wire portion influencing noise to the specified first wire from the wiring arrangement data, and a display controlling unit that generates display information to display the specified first wire and the extracted second wire.

### CROSS-REFERENCE TO RELATED APPLICATION

This application is based upon and claims the benefit of priority of the prior Japanese Patent Application No. 2009-149320 filed on Jun. 24, 2009, the entire contents of which are incorporated herein by reference.

### FIELD

An aspect of the embodiments discussed herein is a circuit design assisting apparatus.

### BACKGROUND

In general layout layer design as physical design of an integrated circuit such as an LSI (Large Scale Integrated circuit), after cells are arranged and wires are arranged between the cells, static noise check (parallel wire length check) is performed in accordance with wire data. The static noise check is performed by executing a batch program, for example. An operator modifies arrangement of the wires in accordance with a result of the check. Note that the batch program is used since a large amount of wire data is used for checking all nets in an integrated circuit to be designed as wires to be checked (victim nets).

In general, a technique of obtaining the result of the check by a CAD (Computer Aided Design) system having a GUI (Graphical User Interface) function and displaying a pair of a check-target wire and an influential wire, performing a modification of the check-target wire in accordance with the result of the check, and rechecking the pair of the wires which have been modified is known.
[Patent Document 1] Japanese Laid-open Patent Publication No. 06-243197

### SUMMARY

According to an aspect of an embodiment, a circuit design assisting apparatus for assisting a circuit design of a semiconductor by using a noise check result corresponding to a plurality of wiring arrangements, the circuit design assisting apparatus includes a database unit that stores the wiring arrangement data, a wire specifying unit that specifies a first wire from the wiring arrangement data, a wire extracting unit that extracts a plurality of second wires respectively including a wire portion influencing noise to the specified first wire from the wiring arrangement data, and a display controlling unit that generates display information to display the specified first wire and the extracted second wire.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a circuit design device according to an embodiment;

FIGS. 2A to 2C are diagrams illustrating a layered configuration when LSI design is performed;

FIG. 3 is a diagram illustrating a model of a net path in detail for describing static noise check (calculation/determination of a 1:1 noise value);

FIG. 4 is a flowchart illustrating a procedure of the LSI design performed by the circuit design device illustrated in FIG. 1;

FIGS. 5A and 5B are flowcharts illustrating operation of a noise check unit illustrated in FIG. 1;

FIG. 6 is a timing chart illustrating error determination (determination of timing when a last trailing edge of a signal waveform is generated) in detail;

FIG. 7 is a flowchart illustrating a procedure of cell arrangement and wiring modification performed along with an operation of displaying a result of noise check;

FIG. 8 is a diagram illustrating a concrete example of display in a first display mode;

FIG. 9 is a diagram illustrating a concrete example of display in a second display mode;

FIG. 10 is a diagram illustrating a concrete example of display in a third display mode;

FIG. 11 is a diagram illustrating a concrete example of display in a fourth display mode;

FIG. 12 is a diagram illustrating a concrete example of display in a fifth display mode;

FIG. 13 is a diagram illustrating a concrete example of the display in the fifth display mode;

FIG. 14 is a diagram illustrating another concrete example of the display in the fifth display mode;

FIG. 15 is a diagram illustrating a concrete example of display in a sixth display mode;

FIG. 16 is a diagram illustrating a concrete example of the display in the sixth display mode;

FIG. 17 is a diagram illustrating another concrete example of the display in the sixth display mode;

FIG. 18 is a diagram illustrating a concrete example of display in a case where the first, second, forth, and fifth display modes are combined with one another;

FIG. 19 is a diagram illustrating a concrete example of display after wiring modification is performed in accordance with the display example illustrated in FIG. 18; and

FIGS. 20A and 20B are diagrams illustrating an example of a procedure of wiring modification.

### DESCRIPTION OF EMBODIMENTS

As described previously, when the check-target wire is modified in accordance with the result of the check in a blind way, an error may occur since an unexpected wire becomes an influential wire after the modification. The occurrence of an error has been a considerably large problem in LSIs having high density and high performance which have been designed in recent years.

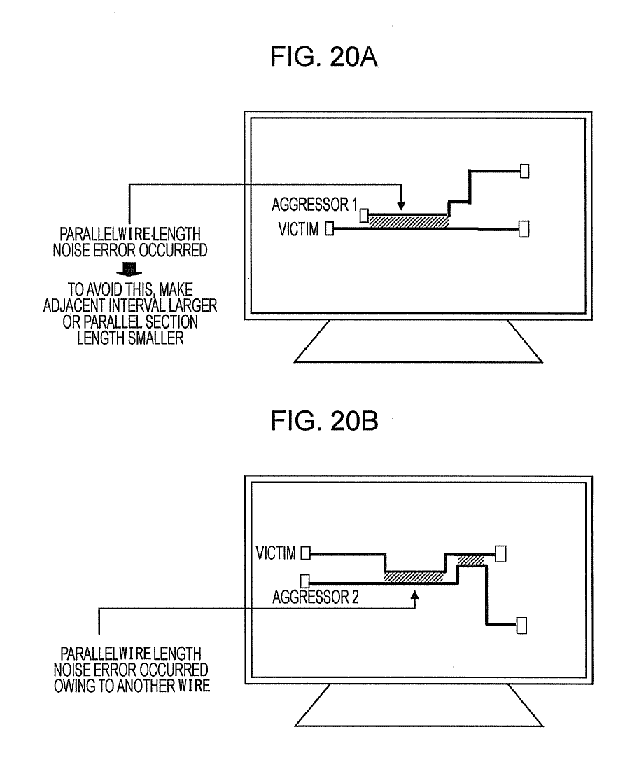

It is assumed that a pair of wires in which a parallel-wire-length noise error has occurred as illustrated in FIG. 20A, that is, a pair of a wired to be modified (Victim: a wire of interest) and an influential wire (Aggressor 1) is displayed in a display unit as the result of the check. In the parallel-wire-length noise error occurring case, an operator performs a modification such that an interval between the wire to be modified and the influential wire is enlarged with reference to the display in the display unit so that a smaller parallel section length is obtained in order to avoid the parallel-wire-length noise error. Even when a problem of occurrence of the error between the wire which has been modified and the influential wire is solved, another wire which has not caused an error may cause the parallel-wire-length noise error as an influential wire (Aggressor 2) as illustrated in FIG. 20B. The operator may repeatedly modify wires until the parallel-wire-length noise error does not occur.

An object of the present embodiment is to efficiently improve static noise utilizing a GUI function.

An embodiment will be described hereinafter with reference to the accompanying drawings.

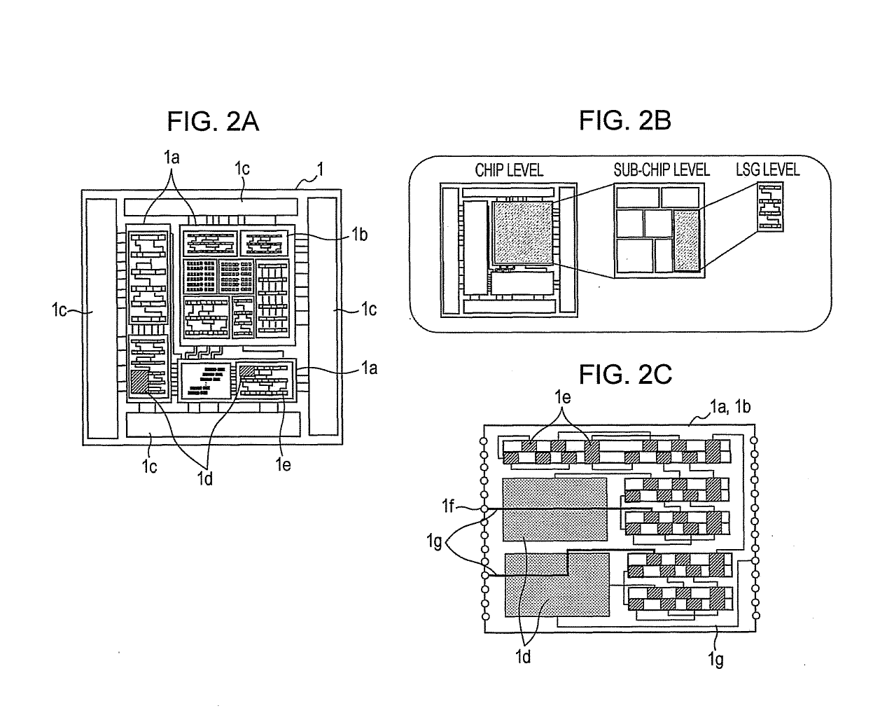

First, a layered configuration of LSI design will be described with reference to FIGS. 2A to 2C.

As illustrated in FIGS. 2A and 2B, when the LSI is designed, an LSI chip 1 to be designed includes three layers, i.e., a layer in a chip level serving as an uppermost layer, a layer in a sub-chip level serving as a middle layer, and a layer in an LSG (Layout Sub Group) level serving as a lowermost layer. In the sub-chip level or the lowermost LSG level, a cell arrangement and inter-cell wiring are performed. Note that the cell arrangement and the inter-cell wiring are performed in the sub-chip level in this embodiment.

As illustrated in FIG. 2A, the LSI chip 1 includes sub-chips 1a, LSGs 1b, external input/output areas (External I/O areas) 1c, custom macro cells 1d, and standard cells 1e included in the sub-chips 1a or the LSGs 1b. Note that the custom macro cells 1d are larger than the standard cells 1e and examples of the custom macro cells 1d include primitive RAMs (Random Access Memories), primitive ROMs (Read Only Memories), and primitive RFs (Radio Frequency circuits).

The custom macro cells 1d are arranged similarly to the standard cells 1e and arranged in the sub-chips 1a or the LSGs 1b together with the standard cells 1e as illustrated in FIG. 2C. Then, wire-and-vias 1g are disposed among the custom macro cells 1d, the standard cells 1e, and module pins 1f.

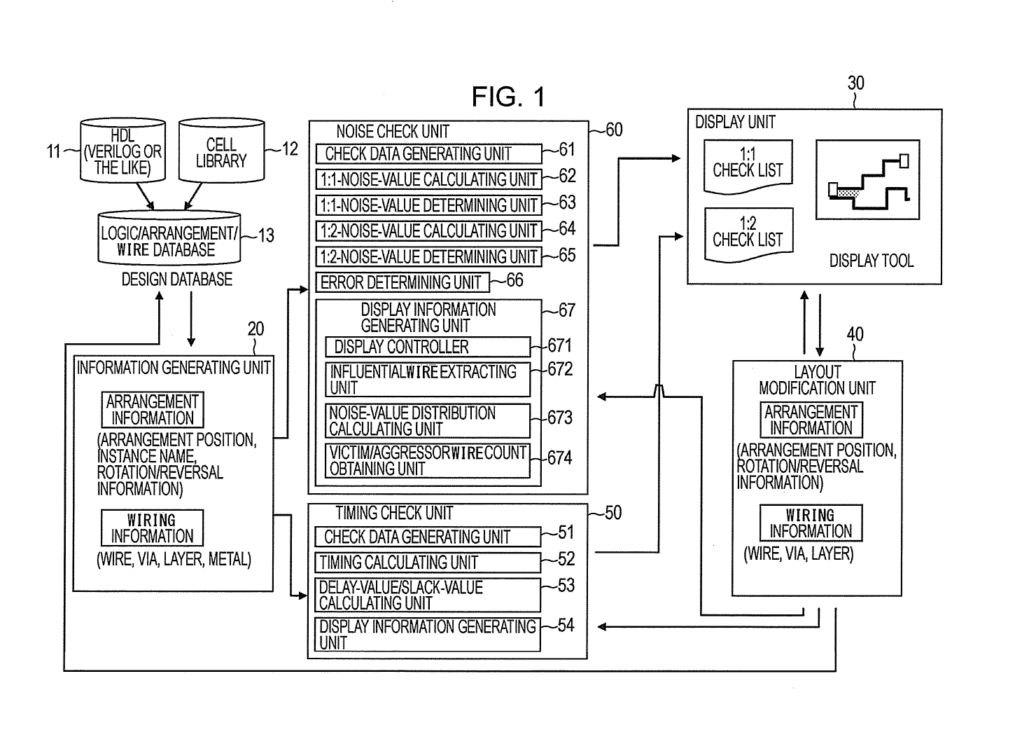

FIG. 1 is a block diagram illustrating a functional configuration of a circuit design device 10 according to an embodiment which designs the LSI chip 1 as illustrated in FIGS. 2A to 2C. As illustrated in FIG. 1, the circuit design device 10 of this embodiment includes an HDL (Hardware Description Language) database 11, a cell library 12, a logic/arrangement/wire database 13, an information generating unit 20, a display unit 30, a layout modification unit 40, a timing check unit 50, and a noise check unit 60.

The HDL database 11 stores design information on a circuit design target described by HDL which is a hardware technique language such as Verilog or VHDL (Very high speed integrated circuits Hardware Description Language).

The cell library 12 stores various types of information regarding the custom macro cells 1d and the standard cells 1e used for circuit design, static timing analysis, and static noise check.

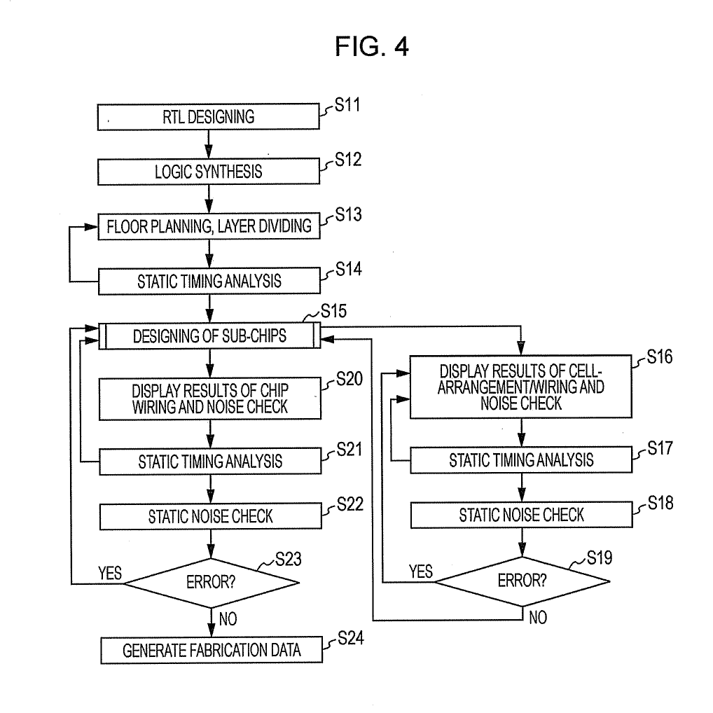

The logic/arrangement/wire database (design database) 13 stores a result of logic synthesis (refer to step S12 of FIG. 4) obtained on the basis of the design information and the various types of information regarding the cells, and a result of cell arrangement and a result of inter-cell wiring (refer to step S16 of FIG. 4). Furthermore, the logic/arrangement/wire database 13 stores a result of arrangement and a result of wiring in the entire circuit design target (refer to step S20 of FIG. 4).

Note that the databases 11 and 13, and the cell library 12 are configured by storage devices such as hard disk drives.

The information generating unit 20 generates arrangement information and wiring information used for check operations performed by the timing check unit 50 and the noise check unit 60 in accordance with the arrangement result and the wiring result stored in the logic/arrangement/wire database 13. Note that the arrangement information relates to the custom macro cells 1d and the standard cells 1e, and includes arrangement positions (coordinate information) of the custom macro cells 1d and the standard cells 1e which have been arranged, instance names, and rotation/reversal information. Furthermore, the wiring information relates to wires arranged among the custom macro cells 1d and the standard cells 1e which have been arranged, and includes wire position information, information on via holes to be passed, and wiring layer information.

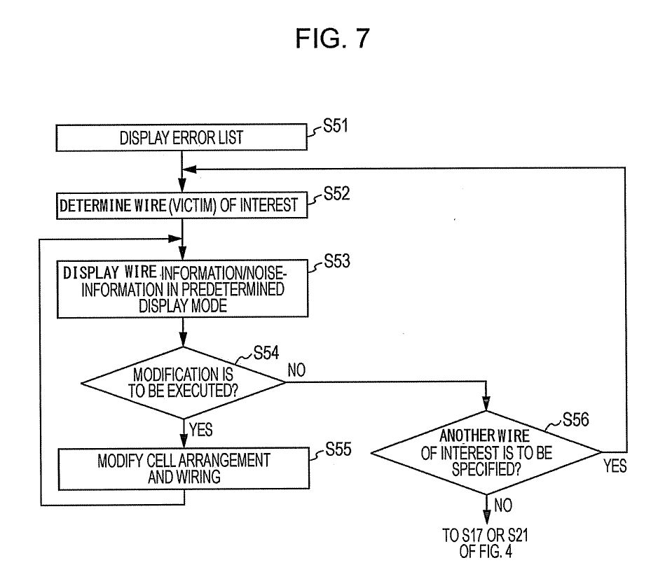

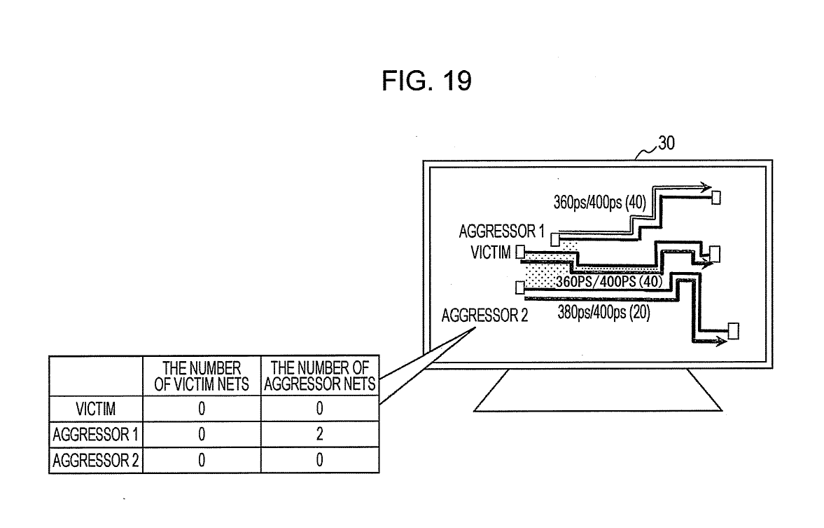

A display state of the display unit 30 is controlled by a display information generating units 54 and 67 described below so that the display unit 30 displays information generated by the display information generating units 54 and 67. The display unit 30 displays an 1:1 check list and an 1:2 check list, which are obtained using the noise check unit 60 described below. Furthermore, the display unit 30 displays a result of timing analysis obtained using the timing check unit 50 in ATW (Arrival Timing Window). Moreover, the display unit 30 performs display in first to sixth modes described below with reference to FIGS. 7 and 19. Note that the display unit 30 is configured by a display device such as a CRT (Cathode Ray Tube) or an LCD (Liquid Crystal Display).

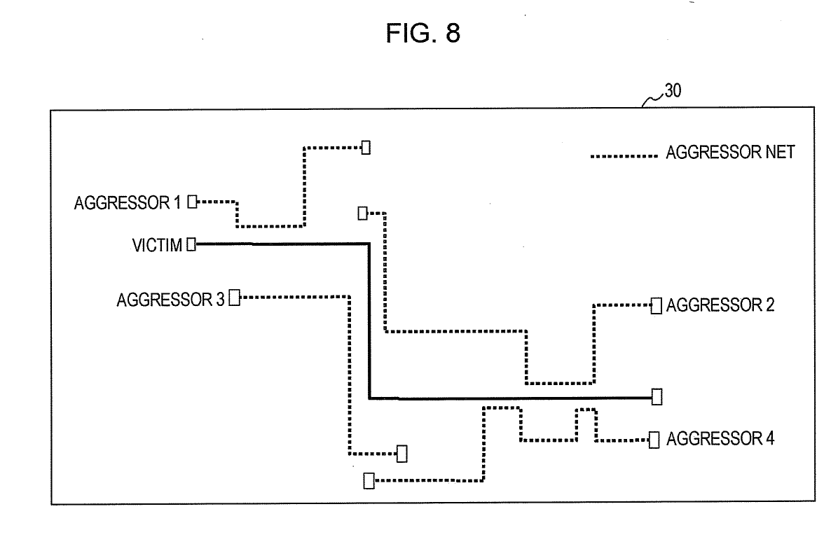

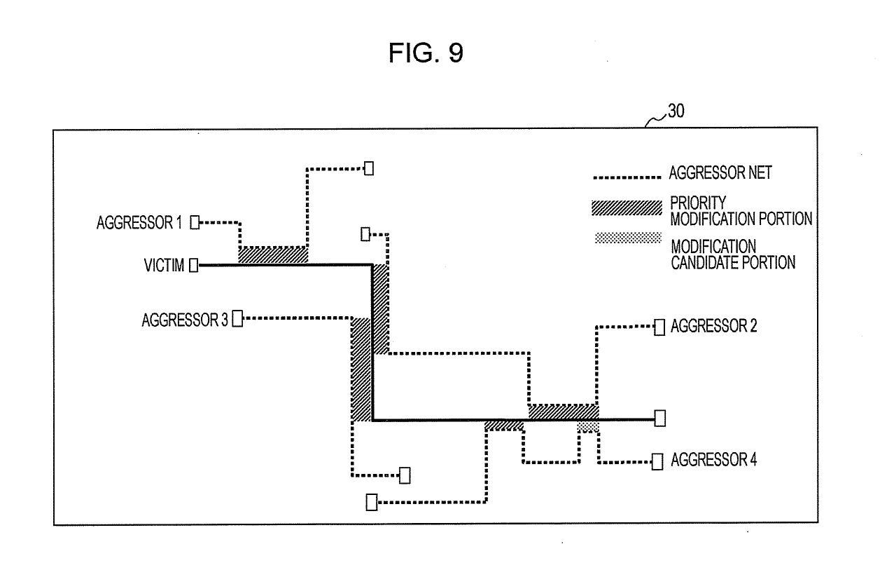

The layout modification unit 40 includes a keyboard operated by an operator who refers to the display unit 30, an input operating device such as a mouse, and an interface between the input operating device and a processor. The layout modification unit 40 functions as a specifying unit which specifies a wire to be modified (a wire of interest or a net of interest) in accordance with an operation performed by the operator after the noise check is performed (and when an noise error occurred). The layout modification unit 40 may specify the wire of interest or the net of interest by the operator from the logic/arrangement/wire database 13. Furthermore, the layout modification unit 40 modifies wiring information regarding the wire to be modified and arrangement information regarding cells and/or macro cells relating to the wire to be modified. Then, the layout modification unit 40 inputs the wiring information and the arrangement information obtained which have been modified in the timing check unit 50, the noise check unit 60, and the logic/arrangement/wire database 13. Furthermore, the layout modification unit 40 has a function of determining a display state of the display unit 30 by selecting one of the first to sixth display modes which will be described hereinafter with reference to FIGS. 8 to 19.

The timing check unit 50 performs the static timing analysis, and checks whether a problem in terms of timing (that is, an error such as delay error or racing error of signals) arose. The timing check unit 50 includes a check data generating unit 51, a timing calculating unit 52, a delay-value/slack-value calculating unit 53, and the delay information generating unit 54.

The check data generating unit 51 generates timing-check data in accordance with the arrangement information and the wiring information supplied from the information generating unit 20.

The timing calculating unit 52 performs delay simulation in the static timing analysis in accordance with the result of the cell arrangement and the result of the inter-cell wiring (the timing check data described above). By the performing delay simulation, timings of signal transmissions in wires are calculated, and a timing chart is obtained.

The delay-value/slack-value calculating unit 53 calculates delay values and slack values of the wires. The slack values correspond to timing margins of drivers of the wires which are obtained in accordance with results of delay simulations, and are calculated using path arrival times relative to cycle times. The slack values are assigned to each of terminals of the drivers of the paths or the wires, respectively. The slack values are calculated as differences between maximum permissible delay values set to the wires and delay values calculated for individual wires.

Note that the maximum permissible delay values of the wires are stored in the logic/arrangement/wire database 13. Furthermore, a timing chart, the slack values, and the delay values obtained using the timing check unit 50 are stored in the logic/arrangement/wire database 13.

Here, the timing chart is displayed in the ATW in the display unit 30 as a result of delay simulations performed by the timing check unit 50. Furthermore, timing information obtained for the display in the ATW is used for a timing determination performed by an error determining unit 66 described below.

The display information generating unit (display controller) 54 generates display information in accordance with results of calculations performed by the timing calculating unit 52 and the delay-value/slack-value calculating unit 53, and controls the display state of the display unit 30 so that the display information is displayed in the display unit 30. By the generating of display information, the timing chart (ATW), the slack values, and the delay values are supplied to the operator through the display unit 30.

The noise check unit 60 performs the static noise check (parallel wire length check) on a result of the cell arrangement and the inter-cell wiring. The noise check unit 60 includes a check data generating unit 61, an one-to-one noise value calculating unit 62, an one-to-one noise value determining unit 63, an one-to-two noise value calculating unit 64, an one-to-two noise value determining unit 65, an error determining unit 66, and the display information generating unit 67.

The check data generating unit 61 generates data used for the static noise check in accordance with the arrangement information and the wiring information supplied from the information generating unit 20.

The one-to-one noise value calculating unit 62 calculates a level of noise generated in a check-target wire (victim) due to an influential wire (aggressor) which extends in the vicinity of and in parallel to the check-target wire as an one-to-one noise value Nv11. The one-to-one noise value Nv11 is calculated by the following equation, for example.

Nv11=Σ{Ln×Ka×f(C, L)} (1)

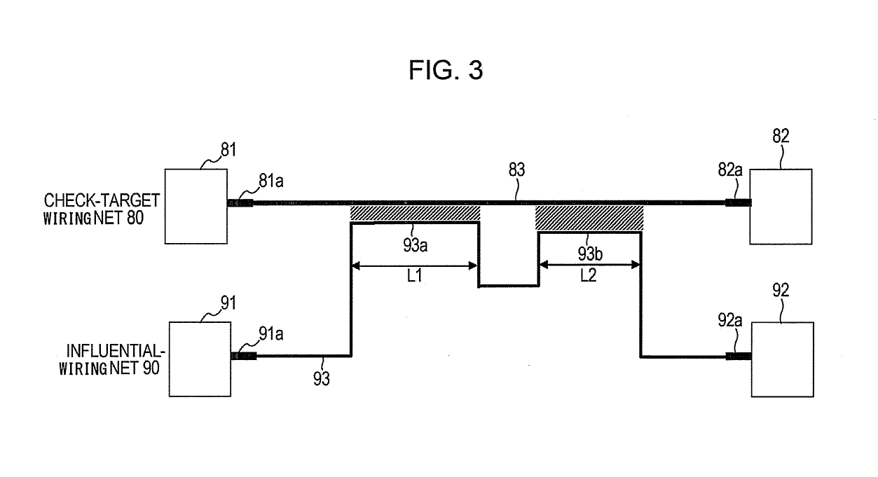

Note that “Nv11” denotes the one-to-one noise value (1:1=victim:aggressor), and “Ln” denotes a wire length (parallel section length or parallel length; refer to FIG. 3, for example) of a section in which a portion of a specific net (aggressor net) extends in the vicinity of and in parallel to a portion of a victim net (check-target wire). Furthermore, “Ka” denotes a check coefficient for the victim net and the aggressor net, and “f(C, L)” denotes a relaxation function using a distance L and a capacitance C as parameters.

The one-to-one noise value determining unit 63 determines whether the one-to-one noise value Nv11 obtained using the one-to-one noise value calculating unit 62 is larger than an one-to-one noise limit value Lx1. The limit value Lx1 is determined in accordance with a combination of a victim net and an aggressor net. When the one-to-one noise value Nv11 is equal to or smaller than the limit value Lx1 (Nv11≦Lx1), the one-to-one noise value determining unit 63 determines that a noise error has not occurred in the check-target wire. On the other hand, when the one-to-one noise value Nv11 is larger than the limit value Lx1 (Nv>Lx1), the one-to-one noise value determining unit 63 determines that an noise error has occurred in the check-target wire. Information regarding the check-target wire determined as described above (an error net data) is output as an error list. The error list may be stored in the logic/arrangement/wire database 13, for example.

The influential wire (aggressor) which relates to the noise check of the check-target wire (victim) is extracted as follows, for example. That is, a wire having a wire section extending in parallel to the check-target wire with a predetermined interval or larger therebetween is extracted as an influential wire. More specifically, for example, in a case where a parallel interval between a wiring pattern of the check-target wire and a wiring pattern of the wire section which are arranged in parallel to each other is 8 grids or smaller, a wire including the wire section is extracted as the influential wire.

Referring to FIG. 3, for example, a wire having wire sections 93a and 93b which have lengths of L1 and L2, respectively, and which are arranged in the vicinity of and in parallel to the check-target wire 83 is determined as an influential wire (aggressor) 93. A level of noise generated in a signal of the check-target wire 83 due to the wire sections 93a and 93b included in the influential wire 93 is obtained as the one-to-one noise value Nv11, and the one-to-one noise value Nv11 is compared with the limit value bd. In the wire model illustrated in FIG. 3, the check-target wire 83 is included in a check-target wiring net (victim net) 80 and connects a driver terminal 81a of a driver cell 81 and a receiver terminal 82a of a receiver cell 82 to each other. Furthermore, the influential wire 93 is included in an influential wiring net (aggressor net) 90 and connects a driver terminal 91a of a driver cell 91 and a receiver terminal 92a of a receiver cell 92 to each other. Note that the cells 81, 82, 91, and 92 correspond to standard cells and custom macro cells.

The one-to-two noise value calculating unit 64 obtains a level of noise generated in a check-target wire which is determined, by the one-to-one noise value calculating unit 62, to have a one-to-one noise value Nv11 equal to or smaller than the limit value Lx1 due to two influential wires (aggressors 1 and 2) which are arranged in the vicinity of and in parallel to the check-target wire as an one-to-two noise value Nv12. The one-to-two noise value Nv12 is calculated in accordance with equation (2) below.

Nv12=(Nv11a+Nv11b)×Kc (2)

Note that “Na11a” denotes an one-to-one noise value (1:1=victim:aggressor 1) between the check-target wire (victim) calculated by the one-to-one noise value calculating unit 62 in accordance with equation (1) and one of the influential wires (aggressor 1). “Nv11b” denotes an one-to-one noise value (1:1=victim:aggressor 2) between the check-target wire (victim) calculated by the one-to-one noise value calculating unit 62 in accordance with equation (1) and the other of the influential wires (aggressor 2). “Kc” denotes a check coefficient for the victim net and the aggressor nets.

The one-to-two noise value determining unit 65 determines whether the one-to-two noise value Nv12 calculated by the one-to-two noise value calculating unit 64 is larger than a limit value Lx2. The limit value Lx2 is determined in accordance with a combination of the victim net and the aggressor net. When the one-to-two noise value Nv12 is equal to or smaller then the limit value Lx2 (Nv12 Lx2), the one-to-two noise value determining unit 65 determines that any noise error has not occurred in the check-target wire. On the other hand, when the one-to-two noise value Nv12 is larger than the limit value Lx2 (Nv12>Lx2), the one-to-two noise value determining unit 65 determines that the check-target wire is an error candidate wire in which it is highly possible that a noise error has occurred.

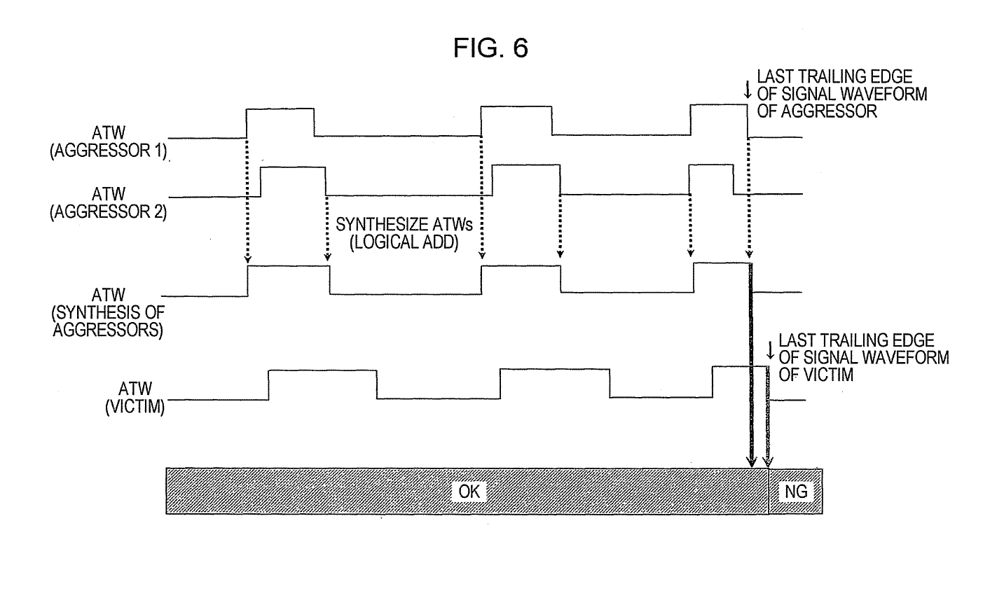

The error determining unit 66 reads timing-chart information (ATW data) read using the timing calculating unit 52 from the logic/arrangement/wire database 13. In accordance with the timing-chart information, the error determining unit 66 compares a timing when a last trailing edge of a signal waveform of a check-target wire determined to have a one-to-two noise value Nv12 larger than the limit value Lx2 is generated with a timing when last trailing edges of signal waveforms of the two influential wires (aggressors 1 and 2) are generated. In accordance with a result of the comparison, the error determining unit 66 determines whether a noise error has occurred in the check-target wire (error candidate wire). In the one-to-two noise value larger than the limit value case, as will be described in detail hereinafter with reference to FIG. 6, the error determining unit 66 synthesizes the signal waveforms of the two influential wires (aggressors 1 and 2) so as to obtain a resultant signal waveform, and compares a timing when a last trailing edge of the resultant signal waveform (logic add of the two signal waveforms) is generated with the timing when the last trailing edge of the check-target wire (victim) is generated.

In a case where the last signal change of the synthesized signal waveform of the influential wires occurred after the last signal change of the check-target wire, it is highly possible that the signal in the check-target wire becomes instable due to the noise generated in the check-target wire affected by the signal change. However, in timings other than the timing described above, even if a noise value in the check-target wire is larger than a limit value, the signal in the check-target wire does not become instable.

Therefore, when it is determined that the timing when the last trailing edge of the synthesized signal waveform is generated comes after the timing when the last trailing edge of the signal waveform of the check-target wire is generated, the error determining unit 66 determines that a noise error has occurred in the check-target wire (error candidate wire). Information (error net data) on the noise error of the check-target wire is output as an error list and stored in the logic/arrangement/wire database 13, for example. On the other hand, when it is determined that the timing when the last trailing edge of the synthesized signal waveform is generated comes before the timing when the last trailing edge of the signal waveform of the check-target wire is generated, the error determining unit 66 determines that the timing of the check-target wire is appropriate even though the one-to-two noise value Nv12 is larger than the limit value Lx2, and the check-target wire is excepted from error candidate wires.

The display information generating unit 67 includes a display controller 671, an influential-wire extracting unit 672, a noise-value distribution calculating unit 673, and a victim/aggressor-wire-count obtaining unit 674.

The display controller 671 generates display information in accordance with a check result (including the error list), for example, obtained using the noise check unit 60, and controls the display state of the display unit 30 so that the display information is displayed in the display unit 30. By the generating display information, the check result obtained using the noise check unit 60 is supplied to the operator through the display unit 30.

The influential-wire extracting unit 672 extracts all wires having wire sections used for noise check of a wire of interest specified by the operator using the layout modification unit 40 as influential wires from the logic/arrangement/wire database 13. For example, all wires having wire sections arranged in parallel to the wire of interest with intervals smaller than a predetermined interval therebetween are extracted as influential wires. The wire sections are referred to as “parallel wire sections” hereinafter where appropriate. Specifically, in a case where a parallel interval between a wiring pattern of the wire of interest and a wiring pattern of a wire section corresponds to 8 grids or smaller, the wire having the wire section is extracted as an influential wire.

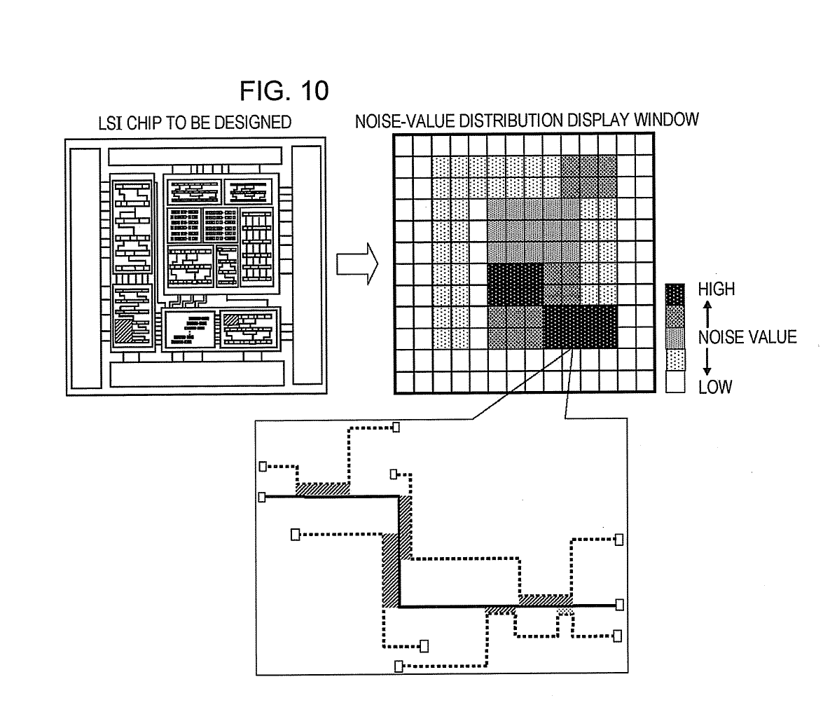

The noise-value distribution calculating unit 673 is used when the third display mode, which will be described below, is selected. The noise-value distribution calculating unit 673 calculates noise-value distribution in an entire circuit design target (entire LSI chip 1) in accordance with a noise check result obtained using the noise check unit 60 and noise values obtained using the one-to-one noise value calculating unit 62, for example. For example, as illustrated in FIG. 10, the noise-value distribution calculating unit 673 obtains total values of noise values calculated for individual areas obtained by dividing the entire circuit design target (entire LSI chip 1) into a matrix.

The victim/aggressor-wire-count obtaining unit 674 is used when the fifth and sixth display modes, which will be described hereinafter, are selected. The victim/aggressor-wire-count obtaining unit 674 obtains the number of victim wires (the number of victim nets) and the number of aggressor wires (the number of aggressor nets) corresponding to the wire of interest specified by the operator and the influential wires extracted using the influential-wire extracting unit 672 in accordance with the noise check result. Note that the victim wires (victim nets) correspond to wires (nets) affected by noise whereas the aggressor wires (aggressor nets) correspond to wires which give noise influence. Here, the victim/aggressor-wire-count obtaining unit 674 also obtains names of the victim wires and the aggressor wires (net names) as well as the number of victim wires and aggressor wires.

The one-to-one noise value calculating unit 62 and the one-to-one noise value determining unit 63 are used when the second display mode is selected as well as when the static noise check is performed.

When the second display mode is selected, the one-to-one noise value calculating unit 62 calculates section noise values “Ln x Ka x f(C, L)” representing levels of noise to be generated in the wire of interest due to the parallel wire sections included in the influential wires in accordance with equation (1) described above. Furthermore, the one-to-one noise value calculating unit 62 calculates total sums “Σ{Ln×Ka×f(C, L)}” of the section noise values “Ln×Ka×f(C, L)” calculated for individual parallel wire sections, as noise values Nv11 for individual influential wires (refer to equation (1) described above). Note that the one-to-one noise value calculating unit 62 may not be operated when the second display mode is selected, but the section noise values “Ln×Ka×f(C, L)” and the entire noise values Nv11 which have been calculated and stored for individual wires using the one-to-one noise value calculating unit 62 may be read when the static noise check is performed.

Furthermore, the second display mode is selected, the one-to-one noise value determining unit 63 performs a determination in accordance with the entire noise values Nv11 calculated using the one-to-one noise value calculating unit 62 and the section noise values “Ln×Ka×f(C, L)”, and therefore, functions as an entire-noise-value determining unit and a section-noise-value determining unit. The entire-noise-value determining unit determines whether the entire noise values Nv11 calculated for individual influential wires using the one-to-one noise value calculating unit 62 are larger than the first limit values bd. Among the influential wires, for influential wires having the entire noise values Nv11 larger than the first limit values Lx1, the section-noise-value determining unit further determines whether section noise values “Ln×Ka×f(C, L)” are larger than the second limit values “K*Nv11”. Note that “K” denotes a coefficient of a positive value larger than 0 and smaller than 1.

Furthermore, the delay-value/slack-value calculating unit 53 is also used when the fourth display mode is selected as described below as well as when the static timing analysis (timing check) is performed.

When the fourth display mode is selected, the delay-value/slack-value calculating unit 53 calculates the slack values of the wire of interest specified by the operator and the influential wires extracted using the influential-wire extracting unit 672 in accordance with delay values of the wires and the maximum permissible delay values. Specifically, differences between the delay values calculated using the delay-value/slack-value calculating unit 53 for individual wires and the maximum permissible delay values read from the logic/arrangement/wire database 13 are calculated as the slack values, respectively. Note that when the fourth display mode is selected, the delay-value/slack-value calculating unit 53 may not be operated and delay values which have been calculated and stored for individual wires using the timing calculating unit 52 at a time of the static timing analysis may be read to be used.

Here, when the noise check unit 60 determined that an noise error has occurred, the display controller 671 controls the display state of the display unit 30 so that the display unit 30 displays reference information used when the operator performs wire modification. The reference information includes a variety of wiring information and information based on the result of the check (including an error list) performed using the noise check unit 60. Here, the display controller 671 controls the display state of the display unit 30 so that the display unit 30 displays the variety of wiring information in a selected one of the first to sixth display mode described below in accordance with the result of the check performed using the noise check unit 60.

When the first display mode is selected, the display controller 671 controls the display unit 30 so that the display unit 30 displays the wire of interest specified by the operator and the influential wires extracted using the influential-wire extracting unit 672. An example of display in the first display mode will be described in detail with reference to FIG. 8.

When the second display mode is selected, the display controller 671 controls the display unit 30 so that the display unit 30 displays parallel wire sections which have been determined that section noise values of Ln×Ka×f(C, L) thereof are larger than second limit values K*Nv11 using the one-to-one noise value determining unit 63 are emphatically displayed as priority modification portions for noise improvement. Furthermore, the display controller 671 controls the display unit 30 so that the display unit 30 displays parallel wire sections which have been determined that entire noise values Nv11 are equal to or smaller than the first limit values Lx1 using the one-to-one noise value determining unit 63 are emphatically displayed in the display unit 30 as modification candidate portions for noise improvement An example of display in the second display mode will be described in detail with reference to FIG. 9.

When the third display mode is selected, the display controller 671 controls the display unit 30 so that the display unit 30 displays noise value distribution in the entire circuit design target (entire LSI chip 1) calculated using the noise-value distribution calculating unit 673. The noise value distribution is displayed in a window other than a window which performs display in the first, second, fourth, fifth, and sixth display modes in the display unit 30. An example of display in the third display mode will be described in detail hereinafter with reference to FIG. 10.

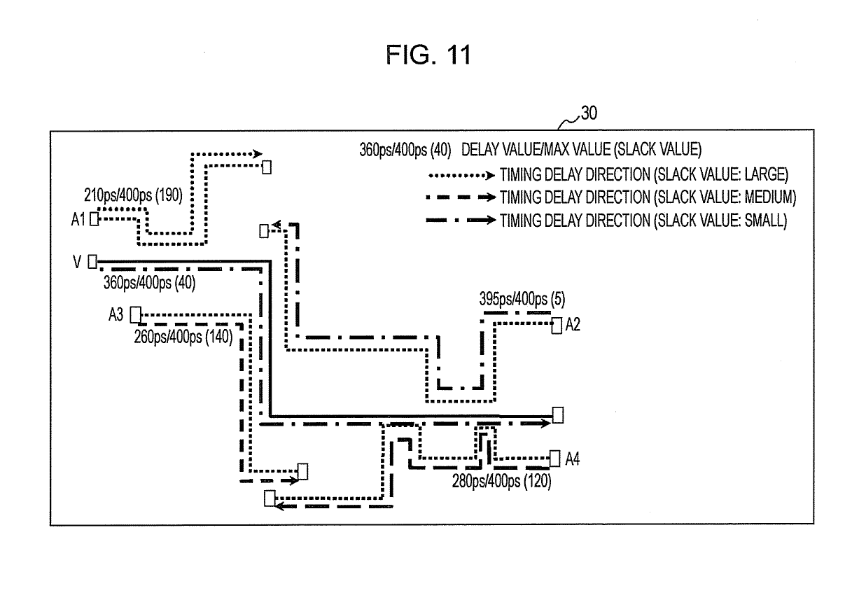

When the fourth display mode is selected, the display controller 671 controls the display unit 30 so that the display unit 30 displays, in addition to the display in the first display mode, slack values calculated for individual wires using the delay-value/slack-value calculating unit 53 so as to correspond to the wires. Note that the display controller 671 performs the control such that the display unit 30 displays arrow marks indicating signal transmission directions of the wires so as to correspond to the wires in a display state in accordance with the slack values obtained for individual wires. Furthermore, the display controller 671 performs control such that the display unit 30 displays the delay values and the maximum permissible delay values of the wires so as to correspond to the wires. An example of display in the fourth display mode will be described hereinafter in detail with reference to FIG. 11.

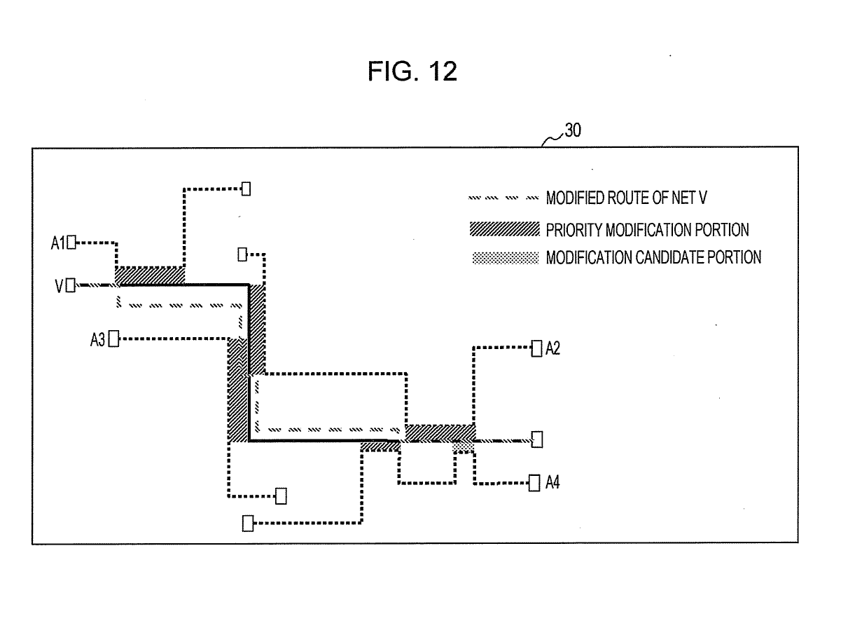

When the fifth display mode is selected, the display controller 671 performs control such that the display unit 30 displays, in addition to the display in the second display mode, the numbers of victim wires (victim nets) and aggressor wires (aggressor nets) obtained using the victim/aggressor-wire-count obtaining unit 674 as a table so as to correspond to the wires. In the case of numbers of victim wires and aggressor wires obtained as a table, the display controller 671 performs control of displaying names (net names) of the victim wires and aggressor wires in the table. An example of display in the fifth display mode will be described in detail hereinafter with reference to FIGS. 12 to 14.

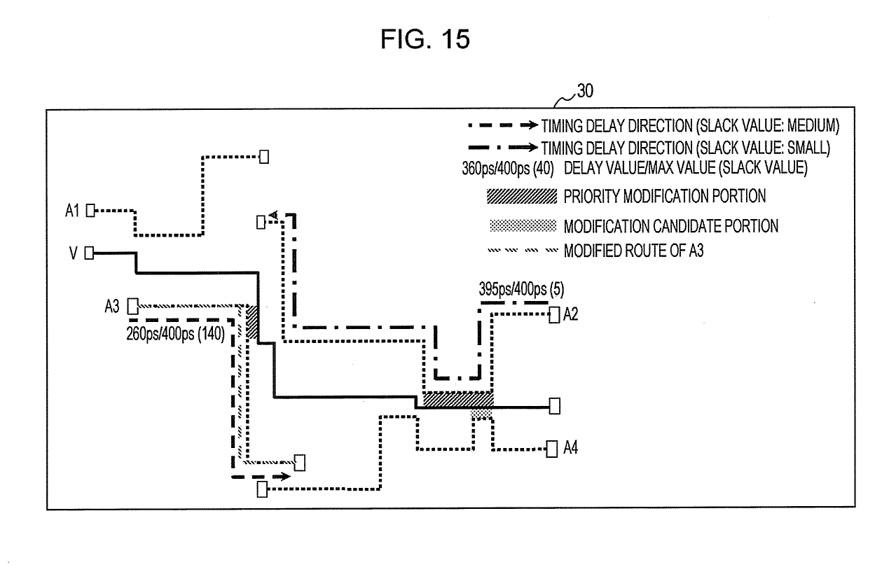

When the sixth display mode is selected, the display controller 671 performs control such that the display unit 30 emphatically displays information on the wires in the table displayed in the fifth display mode in accordance with the slack values of the wires. An example of display in the sixth display mode will be described in detail hereinafter with reference to FIGS. 15 to 17.

The display operations in the first, second, fourth, fifth, and sixth display modes may be performed in an identical window displayed in the display unit 30 or may be performed in different windows. Furthermore, the operations of displaying the table in the fifth and sixth display modes may be performed in different windows.

Moreover, functions of the information generating unit 20, part of the layout modification unit 40, the timing check unit 50, and the noise check unit 60 are realized by executing predetermined circuit design programs by a processor such as a CPU (Central Processing Unit).

Operation of the circuit design device 10 configured as described above will now be described with reference to FIGS. 4 to 19.

In accordance with a flowchart (step S11 to step S24) illustrated in FIG. 4, a procedure of LSI design performed by the circuit design device 10 illustrated in FIG. 1 will be described.

First, design is performed in an RTL (Register Transfer Level) in step S11, logic synthesis is performed in step S12, and floor planning and layer dividing (division of the LSI chip 1 into sub-chips la) are performed in step S13. At this time, the timing check unit 50 performs delay simulation based on static timing analysis in accordance with inter-cell logic lengths in step S14. As results of the static timing analysis performed in accordance with the logic lengths, when it is determined that a problem on a timing (delay or racing of signals, for example) is found, the process returns to step S13, and the floor planning and the layer dividing are performed again. On the other hand, when it is determined that any problem on a timing is not found, design of the sub-chips 1a divided in layers is performed in step S15.

When each of the sub-chips is is designed, in step S16, arrangement of the standard cells 1e and the custom macro cells (large cells) 1d and inter-cell wiring are performed in accordance with a result of the floor planning obtained in step S13. Then, the timing check unit 50 performs delay simulation based on the static timing analysis in accordance with a result of the arrangement of the standard cells 1e and the custom macro cells (large cells) 1d and a result of wiring of the cells 1d and 1e in step S17. By the performing delay simulation, a timing chart (ATW data) regarding signal transmissions in the wires is obtained, slack values of the driver for the wires are calculated, and the timing chart and the slack values are stored in the logic/arrangement/wire database 13.

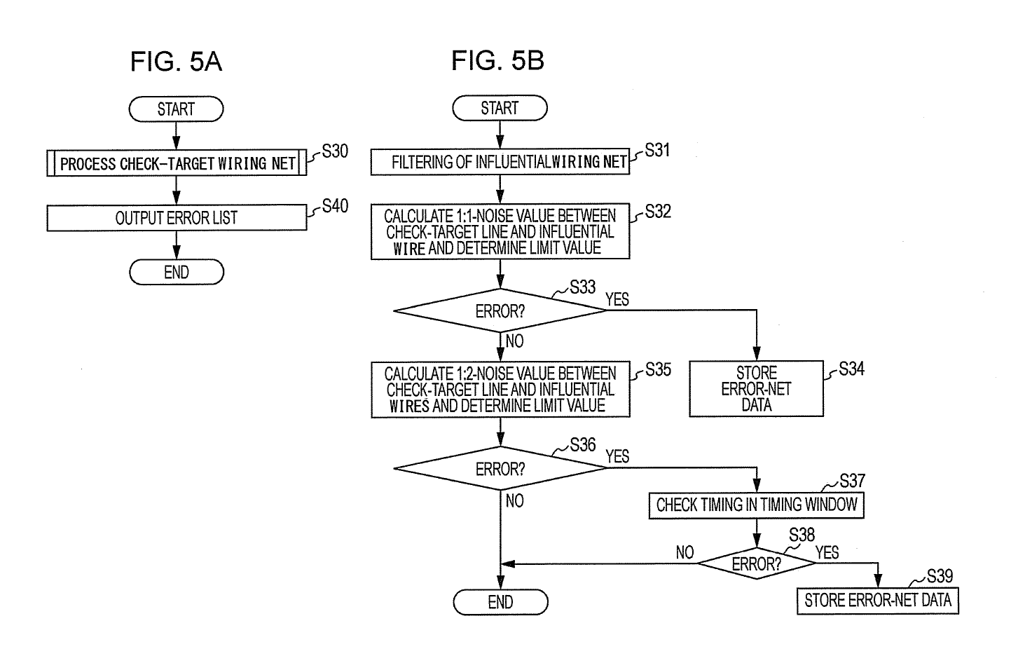

As a result of the static timing analysis, when it is determined that a problem on a timing (an error such as delay or racing of signals) is found, the process returns to step S16 and the cell arrangement d the inter-cell wiring are performed again. On the other hand, when it is determined that any problem on a timing is not found, the noise check unit 60 performs the static noise check on the results of the cell arrangement and the inter-cell wiring in step S18. A procedure of this static noise check, that is, operation of the noise check unit 60 illustrated in FIG. 1 will be described hereinafter with reference to FIGS. 5A and 5B.

As a result of the static noise check, when an error list is obtained (that is, a noise error has occurred; “Yes” is selected in step S19), the process returns to step S16 and the cell arrangement and the inter-cell wiring are performed again. When the error list is obtained, the display unit 30 displays information generated based on the variety of wiring information and the result (including the error list) of the check performed by the noise check unit 60 as reference information which is to be referred to when the operator performs modification of the cell arrangement and the inter-cell wiring. A procedure of the modification of the cell arrangement and the inter-cell wiring performed along with a display operation will be described hereinafter with reference to FIG. 7. Furthermore, the first to sixth display modes in association with the display operation will be described hereinafter with reference to FIGS. 8 to 19.

The processes in step S16 to step S19 are performed for individual sub-chips 1a. Then, the cell arrangement and the inter-cell wiring are performed on all the sub-chips 1a. Thereafter, when it is determined that an error has not occurred on the noise values, wiring of the LSI chip 1 is performed by combining design results (results of the cell arrangement and the inter-cell wiring) of all the sub-chips is with one another in step S20. Then, the timing check unit 50 performs delay simulation based on the static timing analysis in accordance with a result of the wiring in the LSI chip 1 in step S21. By the delay simulation, a timing chart (ATW data) of the signal transmissions of the wires is obtained, the slack values of the driver of the wires are calculated, and the timing chart and the slack values are stored in the logic/arrangement/wire database 13, for example.

As a result of the static timing analysis, when it is determined that a problem on a timing (an error such as delay and/or racing of signals) has found, the process returns to step S15, and the design of the sub-chips is is performed again or the wiring of the LSI chip 1 is performed again in step S20. On the other hand, when it is determined that any problem on a timing has not found, in step S22, the noise check unit 60 performs the static noise check on a result of the wiring of the LSI chip 1 similarly to the process in step S18. A procedure of the static noise check, which is operation of the noise check unit 60 illustrated in FIG. 1 will be described hereinafter with reference to FIGS. 5A and 5B.

As a result of the static noise check, when an error list is obtained (that is, a noise error has occurred; “Yes” is selected in step S23), the process returns to step S15, and the design of the sub-chips is is performed again or the wiring of the LSI chip 1 is performed again in step S20. Also in this case, the display unit 30 displays information generated on the basis of the variety of wiring information and the result (including the error list) of the check performed using the noise check unit 60 as reference information used for modification of the cell arrangement and the inter-cell wiring. An operation for the display will be described hereinafter with reference to FIGS. 7 to 19.

Processes similar to the processes described above (step S15 to step S23) are repeatedly performed until the determination is negative in step S23. When it is determined that any noise error has not occurred (“No” is selected in step S23), fabrication data of the LSI chip 1 is generated in accordance with the design result (the results of the cell arrangement and the inter-cell wires of the entire LSI chip 1) and the design of the LSI chip 1 is terminated.

Operations of the noise check unit 60 in step S18 and step S22 of FIG. 4 will be described in accordance with flowcharts (step S30, step S40, and step S31 to step S39) illustrated in FIGS. 5A and 5B.

After the cell arrangement and the inter-cell wiring are performed and the static timing analysis and the determination of a result of the analysis are performed (in step S16 and step S17 or step S20 and step S21 illustrated in FIG. 4), the noise check unit 60 is activated. By the performing static timing analyzing, as illustrated in FIG. 5A, in step S30, a noise check process is performed on check-target wiring nets (victim nets) as illustrated in FIG. 5B, and error lists obtained through the process is output in step S40.

Next, the process executed in step S30 illustrated in FIG. 5A, that is, the noise check process illustrated in FIG. 5B will be described.

Influential wiring nets (aggressor nets) which may affect a certain check-target wiring net (victim net) are extracted from a result of the inter-cell arrangement by filtering in step S31. Thereafter, the one-to-one noise value calculating unit 62 calculates an one-to-one noise values Nv11 of each of the influential wires (aggressors) relative to the check-target wire (victim) in accordance with equation (1) described above. Then, the one-to-one noise value determining unit 63 determines whether the one-to-one noise value Nv11 calculated using the one-to-one noise value calculating unit 62 is larger than a limit value Lx1 in step S32.

When the one-to-one noise value Nv11 is larger than the limit value Lx1, it is determined that an noise error has occurred in the check-target wire (“Yes” is selected in step S33), and error net data is output and stored in the logic/arrangement/wire database 13 as an error list (a result of one-to-one noise value check) in step S34.

On the other hand, when the one-to-one noise value Nv11 is equal to or smaller than the limit value Lx1, it is determined that any noise error has not occurred in the check-target wire (victim) (“No” is selected in step S33), and the process of the noise check unit 60 proceeds to step S35. In step S35, the one-to-two noise value calculating unit 64 calculates an one-to-two noise value Nv12 between the check-target wire (victim) having the one-to-one noise value Nv11 equal to or smaller than the limit value Lx1 and two influential wires (aggressors 1 and 2) which may affect the check-target wire in accordance with equation (2) described above. The one-to-two noise value determining unit 65 determines whether the one-to-two noise value Nv12 calculated using the one-to-two noise value calculating unit 64 is larger than a limit value Lx2.

When the one-to-two noise value Nv12 is equal to or smaller than the limit value Lx2, it is determined that any noise error has not occurred in the check-target wire (victim) (“No” is selected in step S36), and the noise check unit 60 terminates the process performed on the check-target wire. On the other hand, when the one-to-two noise value Nv12 is larger than the limit value Lx2 (“Yes” is selected in step S36), the check-target wire (victim) is determined as an error candidate wire in which it is highly possible that a noise error has occurred.

When the error candidate wire is obtained, the timing chart information (ATW data) obtained using the timing check unit 50 (timing calculating unit 52) is read from the logic/arrangement/wire database 13. Then, the error determining unit 66 compares a timing when a last trailing edge of a signal waveform of the check-target wire which is determined to have the one-to-two noise value Nv12 larger than the limit value Lx2 by the one-to-two noise value determining unit 65 is generated with timings when last trailing edges of signal waveforms of the two influential wires are generated in accordance with the timing chart information. In accordance with a result of the comparison, a determination of a noise error is performed on the check-target wire in step S37.

Specifically, the error determining unit 66 may obtain the signal waveforms of the influential wires (aggressors 1 and 2) and the check-target wire (victim) as a timing chart (ATW data) as illustrated in FIG. 6, for example. As illustrated in FIG. 6, the noise check unit 60 first synthesizes the signal waveforms of the two influential wires (aggressors 1 and 2) so as to obtain a logic add of the signal waveforms. Then, the noise check unit 60 determines whether a timing when a last trailing edge of the synthesized signal waveform is generated comes after a timing when a last trailing edge of the signal waveform of the check-target wire (victim) is generated (an NG region in FIG. 6) or comes before a timing when the last trailing edge of the signal waveform of the check-target wire (victim) is generated (an OK region in FIG. 6) through a comparison.

As a result of the comparison between the last trailing edge generation timings, if the timing when the last trailing edge of the synthesized signal waveform is generated comes after the timing when the last trailing edge of the signal waveform of the check-target wire is generated (the NG region in FIG. 6), the error determining unit 66 determines that a noise error has occurred in the check-target wire (“Yes” is selected in step S38). Then, error net data is output and stored in a database as an error list (a result of the one-to-two noise value check result) in step S39. On the other hand, if the timing when the last trailing edge of the synthesized signal waveform is generated comes before the timing when the last trailing edge of the signal waveform of the check-target wire is generated (the OK region in FIG. 6), it is determined that a problem on a timing has not occurred in the check-target wire even when the one-to-two noise value Nv12 is larger than the limit value Lx2 (“No” is selected in step S38). When the last trailing edge of the synthesized signal waveform is generated comes before the timing when the last trailing edge of the signal waveform of the check-target wire is generated, the check-target wire is except from error candidate wires, and the noise check unit 60 terminates the process performed on the check-target wire.

The noise check unit 60 performs check of the timings when the last trailing edges are generated in step S37 in accordance with information on the timing chart of signal transmissions in the wires obtained for the ATW. In accordance with a result of the check, the noise check unit 60 determines whether a noise error occurred in the error candidate wire is inconvenient in terms of timing. Only when the noise error occurred in the error candidate wire is inconvenient in terms of timing, the wire is extracted.

When modification (cell rearrangement or inter-cell rewiring) is performed only on such a wire extracted as described above, a modification amount corresponding to noise errors is reduced. Accordingly, labor required for the modification performed to avoid errors is considerably reduced. Furthermore, a degree of freedom of layout design is considerably improved, and load on DA (Design Automation) is considerably reduced. In addition, optimum cell arrangement and optimum inter-cell wiring may be realized. Note that the check of the timings when the last trailing edges are generated performed in step S37 may be similarly performed on the check-target wire which corresponds to the affirmative determination made in step S33.

Next, a procedure of modification of the cell arrangement and the wiring performed along with an operation of displaying a result of noise check will be described with reference to a flowchart (step S51 to step S56) illustrated in FIG. 7. Specifically, a procedure of a process performed when the noise check unit 60 determines that a noise error has occurred (“No” is selected in step S19 and step S23) and a wiring modification is performed again in step S16 and step S20 will be described.

When the noise check unit 60 determines that a noise error has occurred and the process returns to step S16 or S20, the display unit 30 displays, in step S51, error lists read from the logic/arrangement/wire database 13, for example, as illustrated in FIG. 1. The error lists have been stored in step S34 and step S39 in FIG. 5B and correspond to an one-to-one check list (the result of the one-to-one noise value check) and an one-to-two check list (the result of the one-to-two noise value check).

The operator refers to the error lists and specifies a wire of interest (victim) among modification target wires using the layout modification unit (specifying unit) 40 in step S52. When the wire of interest is specified, the display unit 30 performs display in a predetermined display mode in step S53. Here, the predetermined display mode may be a plurality of display modes among the first to sixth display modes which have been set in advance as defaults. Furthermore, the predetermined display mode may be a plurality of display modes selected from among the first to sixth display modes when the operator specifies the wire of interest using the layout modification unit 40.

In the way of selecting from among the first to sixth display modes, the display unit 30 displays a variety of reference information effectively used when the operator performs a wiring modification on the wire of interest, for example. The operator who refers to the reference information performs modification of the cell arrangement and modification of the wire of interest by operating the layout modification unit 40 (“Yes” is selected in step S54 and the process proceeds to step S55). When the modification of the specified wire of interest is terminated or when the modification is not performed (“No” is selected in step S54), and when wiring modification, for example, is performed on another specified wire of interest (“Yes” is selected in step S56), the process returns to step S52, and a process similar to the process described above is performed. On the other hand, when the modification of the specified wire of interest is terminated or when the modification is not performed (“No” is selected in step S54), and when wiring modification, for example, is not performed on another specified wire of interest (“No” is selected in step S56), the process proceeds to step S17 or step S21 of FIG. 4.

The first to sixth display modes will be described hereinafter.

FIG. 8 is a diagram illustrating a concrete example of display in the first display mode.

When the first display mode is selected, the influential-wire extracting unit 672 extracts all wires having wire sections which are arranged in parallel to a wire of interest specified by the operator using the layout modification unit 40 and which are to be subjected to the noise check as influential wires. Note that, as described above, when an interval between an edge of a wiring pattern of the wire of interest and an edge of a wiring pattern of a parallel wire section is equal to or smaller than 8 grids, the wire having such a parallel wire section is extracted as an influential wire.

The wire of interest specified by the operator and the influential wires extracted using the influential-wire extracting unit 672 are displayed in the display unit 30 under control of the display controller 671 as illustrated in FIG. 8. In the example of display illustrated in FIG. 8, the wire of interest (modification target wire) specified by the operator is represented by a solid wire Victim, and all four influential wires having the parallel wire sections to be subjected to the noise check are represented by dotted wires Aggressors 1 to 4. Note that the influential wires (nets) displayed in the first display mode have the wire sections to be subjected to the noise check since the wire sections are arranged adjacent to the wire of interest, that is, the influential wires displayed in the first display mode are not limited to influential wires having the wire sections which actually cause noise errors in the wire of interest.

Accordingly, not only wires in which noise errors have caused but also wires having the wire sections which do not include noise errors but which are arranged in the vicinity of the wire of interest and which are to be subjected to the noise check are also extracted as the influential wires and displayed. That is, the operator may perform wiring modification on the wire of interest while referring to all the influential wires having the parallel wire sections which may cause noise in the wire of interest. Accordingly, the operator may perform the wiring modification while recognizing all the influential wires which may cause parallel-wire-length noise errors due to the wiring modification. Furthermore, static noise is effectively improved utilizing a GUI function.

FIG. 9 is a diagram illustrating a concrete example of display in the second display mode.

When the second display mode is selected, the display controller 671 performs, in addition to the display in the first display mode, display described below.

Specifically, the one-to-one noise value calculating unit 62 calculates section noise values Ln×Ka×f(C, L) representing levels of noise generated in the wire of interest due to the parallel wire sections. Note that, in the display examples illustrated in FIGS. 8 and 9, each of the influential wires Aggressors 1 to 3 includes one parallel wire section, and the influential wire Aggressor 4 includes two parallel wire sections.

Furthermore, the one-to-one noise value calculating unit 62 calculates total sums E{Ln×Ka×f(C, L)} of the section noise values Ln×Ka×f(C, L) calculated for individual parallel wire sections as entire noise values Nv11 for individual influential wires. Here, in the display examples illustrated in FIGS. 8 and 9, since each of the influential wires Aggressors 1 to 3 has the one parallel wire section, entire noise values Nv11 of the influential wires Aggressors 1 to 3 correspond to the section noise values of the individual parallel wire sections. Furthermore, since the influential wire Aggressor 4 has the two parallel wire sections, an entire noise value Nv11 of the influential wire Aggressor 4 corresponds to a sum of the section noise values of the two parallel wire sections. Note that the section noise values Ln×Ka×f(C, L) and the entire noise values Nv11 which have been obtained and stored in the logic/arrangement/wire database 13, for example, at the time of the static noise check may be read from the logic/arrangement/wire database 13 to be used.

Thereafter, the one-to-one noise value determining unit 63 determines whether the entire noise values Nv11 calculated for individual influential wires using the one-to-one noise value calculating unit 62 are larger than the first limit values Lx1. Then, the one-to-one noise value determining unit 63 performs determinations on influential wires having entire noise values Nv11 larger than the first limit values Lx1 as to whether the noise values Ln×Ka×f(C, L) are larger than the second limit values K*Nv11 (0<K<1).

Then, the display controller 671 emphatically displays, in the display unit 30, parallel wire sections which are determined to have the section noise values Ln×Ka×f(C, L) larger than the second limit values K*Nv11 by the one-to-one noise value determining unit 63 as priority modification portions for noise improvement as illustrated in FIG. 9. Here, the display controller 671 emphatically displays, in the display unit 30, parallel wire sections which are determined to have the section noise values Ln×Ka×f(C, L) equal to or smaller than the second limit values K*Nv11 by the one-to-one noise value determining unit 63 as modification candidate portions for noise improvement as illustrated in FIG. 9. Furthermore, the display controller 671 displays, in the display unit 30, the parallel wire sections included in the influential wires determined to have the entire noise values Nv11 equal to or smaller than the first limit values Lx1 by the one-to-one noise value determining unit 63 as modification candidate sections for noise improvement. Note that the priority modification portions have modification priorities higher than those of the modification candidate portions, and are more emphatically displayed than the modification candidate portions by controlling brightness levels or by using various colors. Note that, in the display example illustrated in FIG. 9, one of the two parallel wire sections included in the influential wire “Aggressor 4” corresponds to a priority modification portion and the other corresponds to a modification candidate portion.

Criteria for determinations of the priority modification portions and the modification candidate portions described above are summarized as follows:

Nv11>Lx1 (when Victim and Aggressor have the noise error relationship)

modification candidate portion: section noise=Ln×Ka×f(C, L)≦K*Nv11

priority modification portion: section noise=Ln×Ka×f(C, L)>K*Nv11

Nv11≦Lx1 (when Victim and Aggressor do not have the noise error relationship)

modification candidate portion: adjacent sections

Accordingly, the parallel wire sections which give larger noise influence to the wire of interest are emphatically displayed as the priority modification portions, and the parallel wire sections which give noise influence smaller than those of the priority modification portions to the wire of interest are emphatically displayed as the modification candidate portions. That is, the operator may recognize portions included in the wire of interest to be subjected the wiring modification as the priority modification portions and the modification candidate portions, and further recognize that the priority modification portions have higher priorities than those of the modification candidate portions. Accordingly, the operator may perform the wring modification while recognizing information on the portions to be modified included in the wire of interest. Consequently, improvement of static noise may be efficiently performed utilizing a GUI function.

FIG. 10 is a diagram illustrating a concrete example of display in the third display mode.

When the third display mode is selected, the noise-value distribution calculating unit 673 calculates noise value distribution in the entire circuit design target (entire LSI chip 1) in accordance with noise values obtained using the noise check unit 60 (results of calculations performed using the one-to-one noise value calculating unit 62, for example). Then, the display controller 671 controls the display unit 30 so that the display unit 30 displays the noise value distribution in the entire circuit design target (entire LSI chip 1) calculated using the noise-value distribution calculating unit 673.

The noise value distribution display is performed as illustrated in FIG. 10, for example. In the display example illustrated in FIG. 10 (an upper right side of FIG. 10), the entire circuit design target (entire LSI chip 1) is divided into areas of a matrix of 12 rows×14 columns. Then, display in a plurality of levels (five levels in FIG. 10) corresponding to total values of the noise values calculated in individual areas is performed by controlling brightness levels in the areas or by using different colors. In the entire circuit design target divided case, among the areas, areas having larger noise values are more emphatically displayed. Furthermore, the noise value distribution display is performed in a window different from the window which displays the first, second, fourth, fifth, and sixth display modes in the display unit 30.

It is highly possible that a large amount of heat is generated or malfunction occurs in areas having the larger sums of the noise values. Therefore, by displaying the noise value distribution in the entire circuit design target (entire LSI chip 1) as illustrated in FIG. 10, the operator may immediately recognize such areas in the display unit 30. The operator recognizes and selects such areas, and performs the wiring modification while referring to the display in the other display modes (the first, second, fourth, fifth, and sixth display modes). Accordingly, improvement of the static noise may be efficiently performed utilizing a GUI function.

Note that, when the operator clicks a specific cell in a state in which the noise distribution is displayed as illustrated in FIG. 10, a state of content of the specific cell may be changed from the third display mode to one of the other display modes (first, second, fourth, fifth, and sixth display modes). By the changing display modes, the operator may perform a process of changing the third display mode to one of the other display modes which is a detailed display mode for the specific area and immediately performing the wiring modification and the link on the wire of interest. Accordingly, the wiring modification is more efficiently performed.

FIG. 11 is a diagram illustrating a concrete example of display in the fourth display mode.

When the fourth display mode is selected, the display controller 671 performs, in addition to the display in the first display mode, the following display.

That is, the delay-value/slack-value calculating unit 53 calculates slack values of the wire of interest and the influential wires which are extracted and displayed in the first display mode in accordance with delay values and maximum permissible delay values of the wires. Specifically, differences between the delay values calculated using the delay-value/slack-value calculating unit 53 and the maximum permissible delay values read from the logic/arrangement/wire database 13 are calculated as the slack values for individual wires. Note that the slack values which have been calculated and stored when the static timing analysis is performed may be read from the logic/arrangement/wire database 13.

Then, in addition to the display in the first display mode, the display controller 671 displays the slack values calculated for individual wires using the delay-value/slack-value calculating unit 53 in the display unit 30 as well as the delay values and the maximum permissible delay values of the wires as illustrated in FIG. 11. Furthermore, as illustrated in FIG. 11, arrow marks representing signal transmission directions (timing directions) of the wires are displayed in the display unit 30 along the wires so as to correspond to the slack values calculated for individual wires. Note that display is performed in a plurality of levels (three levels in FIG. 11) in accordance with levels of the slack values (timing margins) of the wires by controlling brightness levels of the arrow marks or by using different colors. Note that, in FIG. 11, the arrow marks are displayed in a plurality of levels by using various types of wires (dotted wires, dashed wires, and dashed-dotted wires).

By the functions of the various display modes, the slack values, the delay values, and the maximum permissible delay values (MAX values) are displayed for individual wires, and the arrow marks representing the signal transmission directions of the wires are displayed in accordance with the timing margins (by using different colors). That is, the operator may immediately recognize wires having large slack values (wires having large timing margins) in the display unit 30. Furthermore, the operator may immediately recognize parallel wire sections included in influential wires having large slack values as sections to be preferentially subjected to the wiring modification by referring to the slack values, the delay values, and the maximum permissible delay values displayed in the display unit 30. Accordingly, the operator may perform the wiring modification while recognizing the information on sections of the wire of interest to be modified, and improvement of the static noise is efficiently performed utilizing a GUI function.

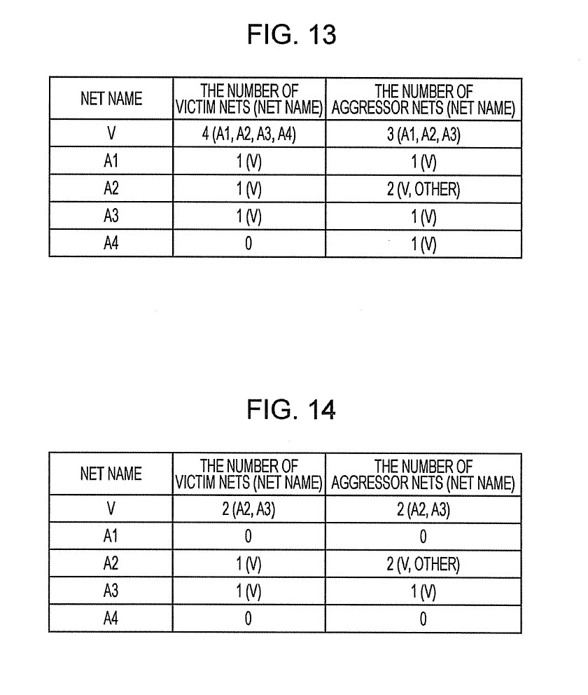

FIG. 12 is a diagram used to illustrate a concrete example of display in the fifth display mode, and FIGS. 13 and 14 are diagrams illustrating concrete examples of the display in the fifth display mode.

When the fifth display mode is selected, the display controller 671 performs display described below in addition to the display in the second display mode illustrated in FIG. 12, for example.

That is, the victim/aggressor-wire-count obtaining unit 674 obtains the numbers of victim wires serving as the numbers of victim nets and the numbers of aggressor wires serving as the numbers of aggressor nets for the wire of interest and the influential wires displayed in the second display mode in accordance with results of the noise check. Note that, in addition to the numbers of victim wires and the numbers of aggressor wires, wire names (net names) of the victim wires and the aggressor wires are also obtained. Note that, in the display examples illustrated in FIGS. 12 to 17, a wire name (net name) of the wire of interest is denoted by “V”, and wire names (net names) of the four influential wires are denoted by “A1” to “A4”.

Then, the display controller 671 displays, in addition to the display in the second display mode illustrated in FIG. 12, the numbers of victim wires (victim nets) and the numbers of aggressor wires (aggressor nets) obtained using the victim/aggressor-wire-count obtaining unit 674 in the display unit 30 as a table illustrated in FIG. 13 so as to correspond to the wires. Here, the wire names (net names) of the victim wires and the aggressor wires are also displayed in the table. The table may be displayed in a display window in the second display mode illustrated in FIG. 12, or may be displayed in a window other than the display window of the second display mode illustrated in FIG. 12.

Referring to the table illustrated in FIG. 13, the wire of interest V which has been specified by the operator is affected by noise caused by the wires A1 to A4, and noise caused by the wire of interest V affects the wires A1 to A3. Furthermore, according to the table illustrated in FIG. 13, the influential wires A1 and A3 are affected by noise caused by the wire V, and noise caused by the influential wires A1 and A3 affect the wire V. Similarly, the influential wire A2 is affected by noise caused by the wire V, and noise caused by the influential wire A2 affects the wire V and a wire “other”. Note that the wire “other” which is affected by the noise caused by the wire A2 is not displayed in the display example illustrated in FIG. 12 and is arranged adjacent to the wire A2. The influential wire A4 is not affected by noise caused by any other wire, but noise caused by the influential wire A4 affects the wire V. Note that, depending on signal strengths of the wires, noise caused by a certain wire may affect other wires but the certain wire may not be affected by noise caused by any other wire. Therefore, the number of victim wires and the number of the aggressor wires are not necessarily equal to each other.

The operator who refers to the table selects wires having the large numbers of aggressor nets and the large numbers of victim nets and preferentially performs the wiring modification on the selected wires for improvement of noise. By the performing wiring modification on the selected wires, the number of processes and the number of setbacks may be reduced. For example, the operator who refers to the table first selects and modifies the wire V. When the operator modifies the wire V as denoted by broken wires denoted by “modified route of net V” illustrated in FIG. 12, using a result of the wire modification, the victim/aggressor-wire-count obtaining unit 674 obtains the numbers of victim nets, the numbers of aggressors, and the net names again, the table illustrated in FIG. 13 is replaced by a table illustrated in FIG. 14, and the table illustrated in FIG. 14 is displayed.

Note that, in the table illustrated in FIG. 14 obtained after the wiring modification illustrated in FIG. 12, the wire of interest V is affected by noise caused by the wires A2 and A3 and noise caused by the wire of interest affects the wires A2 and A3. Furthermore, the influential wires A1 and A4 are not affected by noise caused by the other wires and noise caused by the influential wires A1 and A4 does not affect any other wire. The influential wires A2 and A3 are not changed from those of the table illustrated in FIG. 13. The operator who refers to the table illustrated in FIG. 14 next performs the wiring modification on the influential wire A2 or A3.

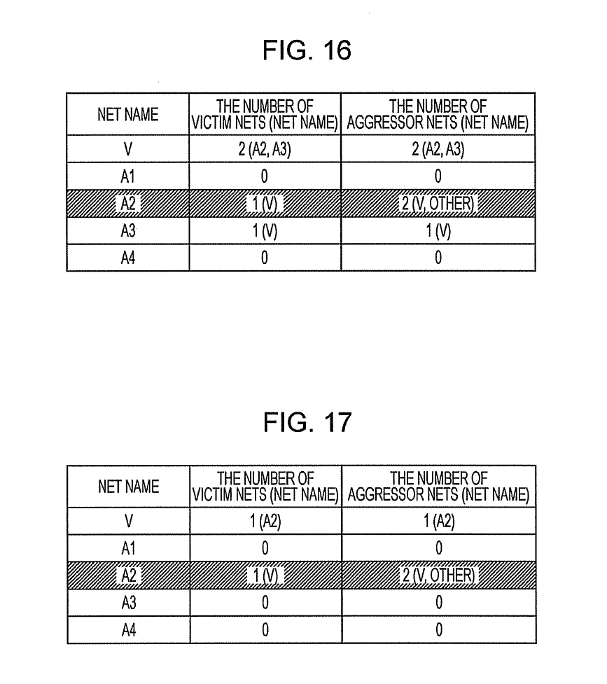

FIG. 15 is a diagram used to illustrate a concrete example of display in the sixth display mode. FIGS. 16 and 17 are diagrams illustrating concrete examples of the display in the sixth display mode.

When the sixth display mode is selected, the display controller 671 performs display as described below in addition to the display in the second display mode illustrated in FIG. 15 and display of a table illustrated in FIG. 16. Note that FIG. 15 illustrates a wiring state obtained after the wire of interest V is modified in the display example illustrated in FIG. 12. FIG. 16 illustrates a state in which the display in the sixth display mode is performed on the table illustrated in FIG. 14 obtained after the wiring modification is performed as illustrated in FIG. 12.

When the sixth display mode is selected, as with the fourth display mode, the slack values of the wires are obtained, and the display controller 671 emphatically displays information on the wires included in the table displayed in the fifth display mode in accordance with the slack values of the wires as illustrated in FIG. 16. Furthermore, as with the fourth display mode, as illustrated in FIG. 15, the slack values, the delay values, and the maximum permissible delay values of the wires A2 and A3 to be subjected to the wiring modification are displayed in the display unit 30. Furthermore, arrow marks representing signal transmission directions (timing directions) are also displayed along the wires in the display unit 30 in display states corresponding to the slack values.

In the sixth display mode selected case, the slack value of the wire A2 is 5 (a maximum value is 400) and the slack value of the wire A3 is 140 (a maximum value is 400). That is, the wire A2 has a small timing margin whereas the wire A3 has a large timing margin. That is, it is difficult to modify the wire A2 in terms of delay, and in the table illustrated in FIG. 16, information on the wire A2 is displayed by hatching so that the operator may recognize that a modification priority of the wire A2 is low. Note that, instead of the hatching, information on a wire having a high modification priority (information on the wire A3 in this case) may be arranged on an upper side of the table while the information on the wire A2 is arranged on a lower side of the table. Alternatively, emphasis display in a plurality of levels depending on the modification priorities (slack values) may be performed by controlling brightness levels or by using various colors.

The operator who refers to the table may select the wire A3 having the high modification priority and preferentially perform the wiring modification for improvement of noise on the wire A3 whereby the number of processes and the number of setbacks may be reduced. For example, the operator who refers to the table illustrated in FIG. 16 first selects and modifies the wire A3. Here, when the operator modifies the wire A3 as denoted by a broken wire denoted by “modified route of A3”, using a result of the wiring modification, the victim/aggressor-wire-count obtaining unit 674 obtains the numbers of victim nets, the numbers of aggressor nets, and the net names again. The table illustrated in FIG. 16 is replaced by a table illustrated in FIG. 17, and the table illustrated in FIG. 17 is displayed.

According to the table illustrated in FIG. 17 obtained after the wiring modification illustrated in FIG. 15, it is apparent that the wire of interest V is affected by noise caused by the wire A2 and noise caused by the wire of interest V affects the wire A2. Furthermore, the influential wires A1, A3, and A4 are not affected by noise caused by the other wires and noise caused by the influential wires A1, A3, and A4 does not affect any other wire. The influential wire A2 is not changed from a state of the table illustrated in FIG. 16. The operator who refers to the table illustrated in FIG. 17 next specifies the influential wire A3 as a wire of interest, and performs the wiring modification on the influential wire A3.

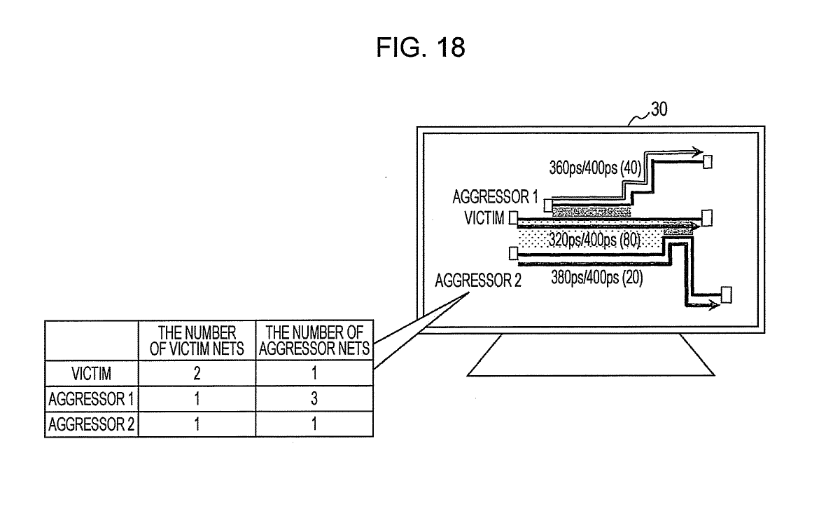

The first to sixth display modes may be individually operated or may be operated in combination. For example, FIG. 18 is a diagram illustrating a concrete example of display in a case where the first, second, forth, and fifth display modes are combined with one another. FIG. 19 is a diagram illustrating a concrete example of display after wiring modification is performed in accordance with the display example illustrated in FIG. 18. Note that a combination of the display modes is not limited to the display example illustrated in FIGS. 18 and 19, and various combinations may be employed.

Note that the present technique is not limited to the foregoing embodiment, and various modifications may be made without departing from the spirit of the present technique.

For example, in the foregoing embodiment, the case where one-to-one noise values and one-to-two noise values are combined with each other for noise error determination has been described. However, the present technique is not limited to this, and the noise error determination may be performed using the one-to-one noise values and one-to-m noise values (m is a natural number equal to or larger than 3) in combination. Alternatively, the noise error determination may be performed using one-to-one noise values, one-to-two noise values, and at least a one-to-m noise value in combination.

Furthermore, the functions of the timing check unit 50 and the noise check unit 60 (entire functions or part of functions) are realized by executing predetermined application programs (circuit design programs) using a computer (including a CPU, an information processing apparatus, and various terminals).

The programs are provided by being recorded in a computer readable recording medium such as a flexible disk, a CD (including a CD-ROM, a CD-R, and a CD-RW), or a DVD (including a DVD-ROM, a DVD-RAM, a DVD-R, a DVD-RW, a DVD+R, a DVD+RW, and a blu-ray disc). In this case, the computer reads the programs from the recording medium and transmits the programs to an internal storage device or an external storage device to use the programs.

Note that the computer includes hardware and an OS (Operating System) and specifically means the hardware operating under control of the OS. Furthermore, in a case where the hardware is operated independently by the application programs without the OS, the hardware itself corresponds to the computer. The hardware includes at least a microprocessor such as a CPU and means for reading computer programs recorded in recording media. The circuit design programs described above include program codes which make the computer realize the functions of the timing check unit 50 and the noise check unit 60. Part of the functions may be executed by the OS instead of the application programs.

All examples and conditional language recited herein are intended for pedagogical purposes to aid the reader in understanding the embodiment and the concepts contributed by the inventor to furthering the art, and are to be construed as being without limitation to such specifically recited examples and conditions, nor does the organization of such examples in the specification relate to a illustrating of the superiority and inferiority of the embodiment. Although the embodiment of the present invention has been described in detail, it should be understood that the various changes, substitutions, and alterations could be made hereto without departing from the spirit and scope of the invention.

What is claimed is:

1. A circuit design assisting apparatus for assisting a circuit design of a semiconductor by using a noise check result corresponding to a plurality of wiring arrangements, the circuit design assisting apparatus comprising:
a database unit that stores the wiring arrangement data;
a wire specifying unit that specifies a first wire from the wiring arrangement data;
a wire extracting unit that extracts a plurality of second wires respectively including a wire portion influencing noise to the specified first wire from the wiring arrangement data; and
a display controlling unit that generates display information to display the specified first wire and the extracted second wire.

2. The circuit design assisting apparatus according to claim 1, wherein a distance between the specified first wire and each of a wire portion of the plurality of second wires is within a predetermined distance.

3. The circuit design assisting apparatus according to claim 1, further comprising
a noise value calculating unit that calculates a section noise value representing a level of noise influencing to the specified first wire by each of the wire portion of the extracted second wires, and calculates a total sum of the section noise values of the extracted second wires,
an entire noise value determining unit that determines whether the calculated entire noise value is greater than a first predetermined value, and
a portion noise value determining unit that determines whether each of the section noise value is greater than a second predetermined value when the calculated entire noise value is greater than the first predetermined value,
wherein the display controlling unit generates the display information to display emphatically the wire portion of the extracted second wires when the section noise value is greater than or equal to the second predetermined value.

4. The circuit design assisting apparatus according to claim 1, further comprising
a noise value calculating unit that calculates a section noise value representing a level of noise influencing to the specified first wire by each of the wire portion of the extracted second wires, and calculates a total sum of the section noise values of the extracted second wires,
an entire noise value determining unit that determines whether the calculated entire noise value is greater than a first predetermined value, and
a portion noise value determining unit that determines whether each of the section noise value is greater than a second predetermined value when the calculated entire noise value is greater than the first predetermined value,
wherein the display controlling unit generates the display information to display emphatically the wire portion of the extracted second wires when the section noise value is less than or equal to the second predetermined value.

5. The circuit design assisting apparatus according to claim 3, wherein the display controlling unit generates the display information to display emphatically the wire portion of the extracted second wires when the entire noise value is less than or equal to the first predetermined value.

6. The circuit design assisting apparatus according to claim 3, wherein the second predetermined value is obtained by multiplying the first predetermined value by a positive coefficient value smaller than 1.

7. The circuit design assisting apparatus according to claim 3, further comprising
a noise value distribution calculating unit that calculates a noise value distribution in an entire circuit design target in accordance with the noise check result,
wherein the display controlling unit generates display information to display the noise value distribution in the entire circuit design target.

8. The circuit design assisting apparatus according to claim 1, further comprising
a slack value calculating unit that calculates slack values of the specified first wire and the extracted second wires in accordance with a delay value of the specified first and the extracted second wirings and a maximum permissible delay value, respectively,
wherein the display controlling unit generates display information to display the slack value in accordance with the specified first wire and the extracted second wires.

9. The circuit design assisting apparatus according to claim 1, wherein the display controlling unit generates display information to display a predetermined figure indicating a signal transmission direction, and predetermined figure is displayed in accordance with the each slack value of the specified first wire and the extracted second wires.

10. The circuit design assisting apparatus according to claim 8, wherein the display controlling unit generates display information to display the delay value of the specified first wire and the extracted second wires and the maximum permissible delay value.

11. The circuit design assisting apparatus according to claim 1, further comprising
a victim/aggressor wiring number obtaining unit that obtains a number of victim wires noise influenced by aggressor wires and a number of the aggressor wires influencing noise to the victim wires,
wherein the display controlling unit generates display information to display the number of the victim wires and the number of aggressor wires.

12. The circuit design assisting apparatus according to claim 11, wherein the display controlling unit generates display information to display a name of the victim wires and a name of the aggressor wires.

13. The circuit design assisting apparatus according to claim 11, wherein the display controlling unit generates display information to display emphatically information about the specified first wire and the extracted second wires based on the slack value of the specified first wire and the extracted second wires.

14. A circuit design assisting method for assisting a circuit design of a semiconductor by using a noise check result corresponding to a plurality of wiring arrangements, the circuit design assisting method comprising:
specifying a first wire from the wiring arrangement data stored in a database unit;
extracting a plurality of second wires respectively including a wire portion influencing noise to the specified first wire from the wiring arrangement data; and
generating display information to display the specified first wire and the extracted second wire.

15. A computer readable medium storing a circuit design assisting program to be executed to perform a process for assisting a circuit design of a semiconductor by using a noise check result corresponding to a plurality of wiring arrangements, the process comprising:
specifying a first wire from the wiring arrangement data stored in a database unit;
extracting a plurality of second wires respectively including a wire portion influencing noise to the specified first wire from the wiring arrangement data; and
generating display information to display the specified first wire and the extracted second wire.

16. The process according to claim 15, wherein a distance between the specified first wire and each of a wire portion of the plurality of second wires is within a predetermined distance.

17. The process according to claim 15, further comprising
calculating a section noise value representing a level of noise influencing to the specified first wire by each of the wire portion of the extracted second wires, and calculates a total sum of the section noise values of the extracted second wires,
determining whether the calculated entire noise value is greater than a first predetermined value, and
determining whether each of the section noise value is greater than a second predetermined value when the calculated entire noise value is greater than the first predetermined value,
wherein the generating generates the display information to display emphatically the wire portion of the extracted second wires when the section noise value is greater than or equal to the second predetermined value.

18. The process according to claim 15, further comprising
calculating a section noise value representing a level of noise influencing to the specified first wire by each of the wire portion of the extracted second wires, and calculates a total sum of the section noise values of the extracted second wires,
determining whether the calculated entire noise value is greater than a first predetermined value, and
determining whether each of the section noise value is greater than a second predetermined value when the calculated entire noise value is greater than the first predetermined value,
wherein the generating generates the display information to display emphatically the wire portion of the extracted second wires when the section noise value is less than or equal to the second predetermined value.

19. The process according to claim 17, wherein the generating generates the display information to display emphatically the wire portion of the extracted second wires when the entire noise value is less than or equal to the first predetermined value.

20. The process according to claim 17, wherein the generating generates the display information to display emphatically the wire portion of the extracted second wires when the entire noise value is less than or equal to the first predetermined value.
